(19) United States
(12) Patent Application Publication
(10) Pub. No.: US 2016/0011627 A1
(43) Pub. Date: Jan. 14, 2016

(54) INPUT DEVICE, PROTECTIVE COVER AND COMBINATION THEREOF

(71) Applicant: OZAKI INTERNATIONAL CO., LTD., NEW TAIPEI CITY (TW)

(72) Inventor: Chang-Hsi Lin, New Taipei City (TW)

(21) Appl. No.: 14/530,478

(22) Filed: Oct. 31, 2014

(30) Foreign Application Priority Data
Jul. 11, 2014 (TW) 103212373

(51) Int. Cl. G06F 1/16; A45C 11/00

(52) U.S. Cl. CPC G06F 1/1633; A45C 11/00; A45C 2011/002; A45C 2011/003; A45C 2011/001

(57) ABSTRACT

An input device, protective cover and combination thereof is provided. The protective cover includes a base plate and a plurality of lateral walls, a first positioning portion and a first magnetic portion. The lateral walls are connected to a periphery of the base plate to define an accommodating space for accommodating a mobile device. The first positioning portion is disposed at an outer surface of the base plate The first magnetic portion is disposed at the base plate. The input device includes an input region, a frame region, a second positioning portion and a second magnetic portion. The second positioning portion is disposed at the frame region and detachably engaged with the first positioning portion. The second magnetic portion is disposed at the frame region and magnetically and detachably adhered with the first magnetic portion; thereby, the input device is detachably fastened with the protective cover.

### CROSS-REFERENCES TO RELATED APPLICATIONS

This non-provisional application claims priority under 35 U.S.C. §119(a) on Patent Application No. 103212373 filed in Taiwan, R.O.C. on Jul. 11, 2014, the entire contents of which are hereby incorporated by reference.

### BACKGROUND

1. Technical Field

The present invention relates to a combination of an input device and a protective cover, and more particular to a combination of an input device and a protective cover in which the input device is detachably combinable with the protective cover.

2. Related Art

Accompanying industrial and commercial developments, information dissemination has become rapid, and mobile devices are widely utilized as telecommunication and entertainment devices. Existing mobile devices, such as tablets and mobile phones, use touch screens assembled therewith as the input devices. The touch screens allow users to input text via fingers or stylus pens, so the user can write text or zoom in on the OS windows of the mobile devices without using traditional computer input devices such as keyboards and mice.

Additionally, since the aforementioned mobile devices are not very cheap, many users would purchase protective covers to protect the mobile devices from rubbing or impacting. Furthermore, the existing mobile devices use touch screens as virtual keyboards for text input; however, most people are used to inputting text using physical keyboards since virtual keyboard input speed is significantly slower than physical keyboard input speed. Consequently, physical keyboards cannot be replaced by virtual keyboards, prompting the invention of wireless keyboards and similar input devices.

Use of wireless keyboards speeds up text input on mobile devices; however, users may forget to carry the wireless keyboard, since the wireless keyboard and the mobile device are separated from each other. Additionally, if these devices are carried improperly, unnecessary damage may occur.

### SUMMARY

In view of this, the present invention provides an input device, a protective cover and a combination thereof. The protective cover includes a base plate and a plurality of lateral walls, at least one first positioning portion and at least one first magnetic portion. The lateral walls are connected to a periphery of the base plate so as to define an accommodating space for accommodating a mobile device along with the base plate. The at least one first positioning portion is disposed at an outer surface of the base plate, and the outer surface is opposite to an opening of the accommodating space. The at least one first magnetic portion is disposed at the base plate. The input device includes an input region, a frame region, at least one second positioning portion and at least one second magnetic portion. The frame region surrounds the input region. The at least one second positioning portion is disposed at the frame region and detachably engaged with the at least one first positioning portion. The at least one second magnetic portion is disposed at the frame region and magnetically and detachably adhered with the first magnetic portion; thereby, the input device is detachably fastened with the outer surface of the protective cover.

In conclusion, the protective cover and the input device can be combined with each other or detached from each other with the application of the first magnetic portion and the second magnetic portion. Additionally, with the fool-proofing structure profiles, the second positioning portion can be engaged easily with the first positioning portion, thereby allowing the user to detachably fasten the input device with the protective cover conveniently. Furthermore, with the engagement between the first positioning portion and the second positioning portion, the connection between the input device and the protective cover can be improved to avoid the input device detaching from the protective cover upon being impacted unintentionally.

A detailed description of the characteristics and the advantages of the present invention is shown in the following embodiments. The technical content and the implementation of the present invention should be readily apparent to any person skilled in the art from the detailed description, and the purposes and the advantages of the present invention should be readily understood by any person skilled in the art with reference to content, claims and drawings in the present invention.

### BRIEF DESCRIPTION OF THE DRAWINGS

The present invention will become more fully understood from the detailed description given herein below for illustration only, and thus not limitative of the present invention, wherein:

FIG. 1 is a perspective view of an exemplary embodiment of a combination of an input device and a protective cover according to the present invention;

FIG. 2 is an exploded view of the exemplary embodiment of the combination of an input device and a protective cover according to the present invention;

FIG. 3 is another perspective view of the exemplary embodiment of the combination of an input device and a protective cover according to the present invention;

FIG. 4 is another exploded view of the exemplary embodiment of the combination of an input device and a protective cover according to the present invention;

FIG. 5 is a lateral view of the exemplary embodiment of the combination of an input device and a protective cover according to the present invention; and

FIG. 6 is another lateral view of the exemplary embodiment of the combination of an input device and a protective cover according to the present invention.

### DETAILED DESCRIPTION

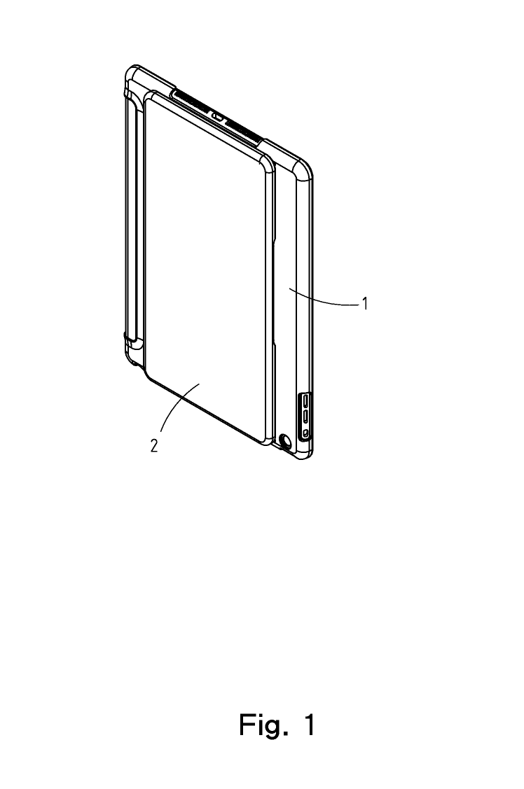

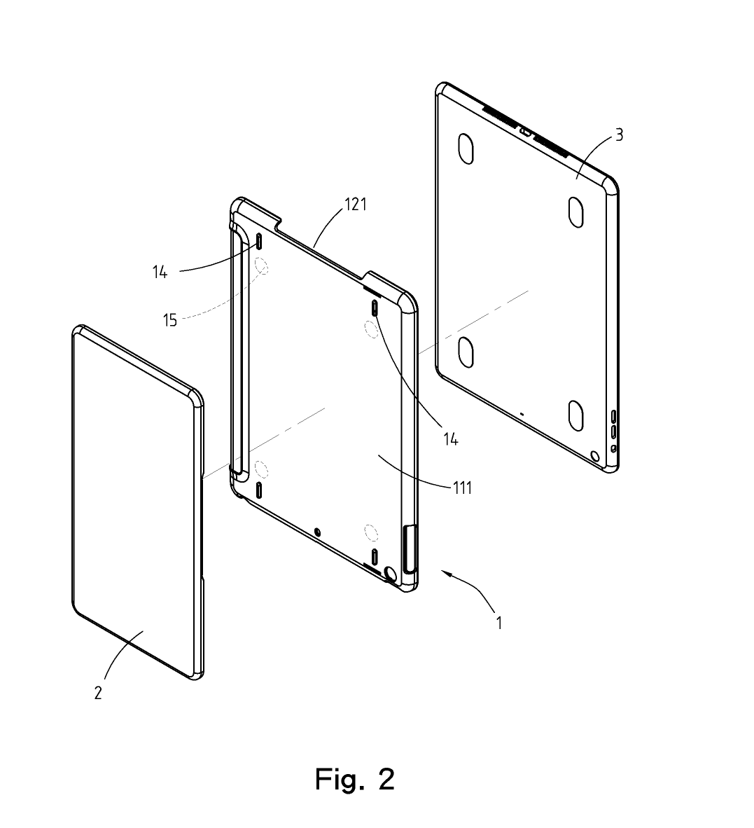

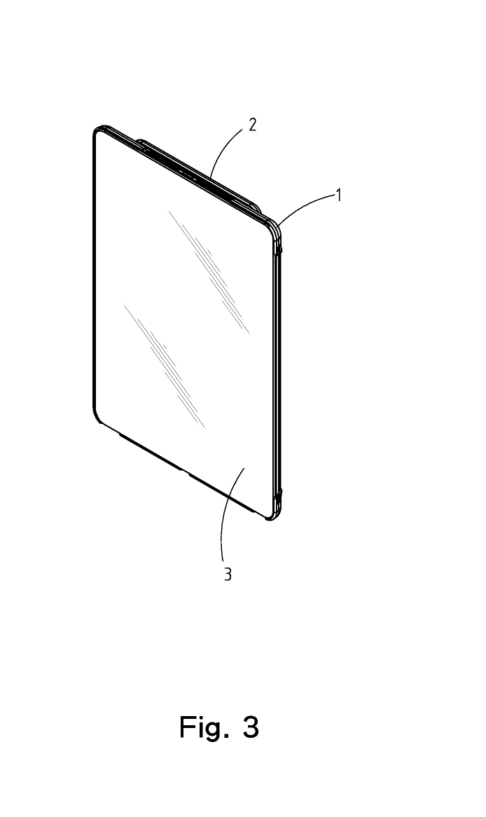

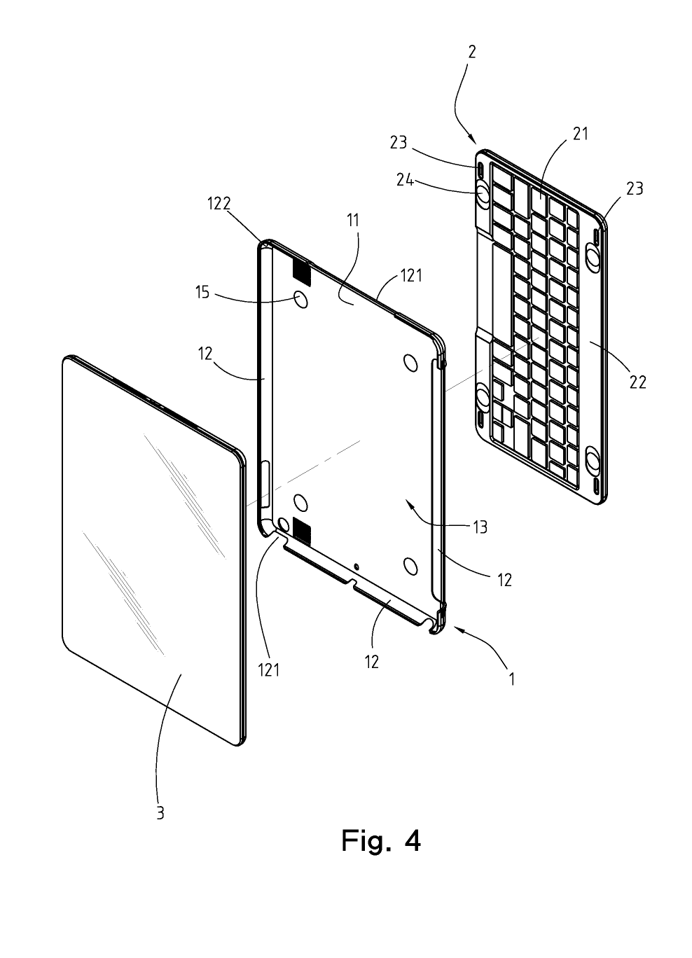

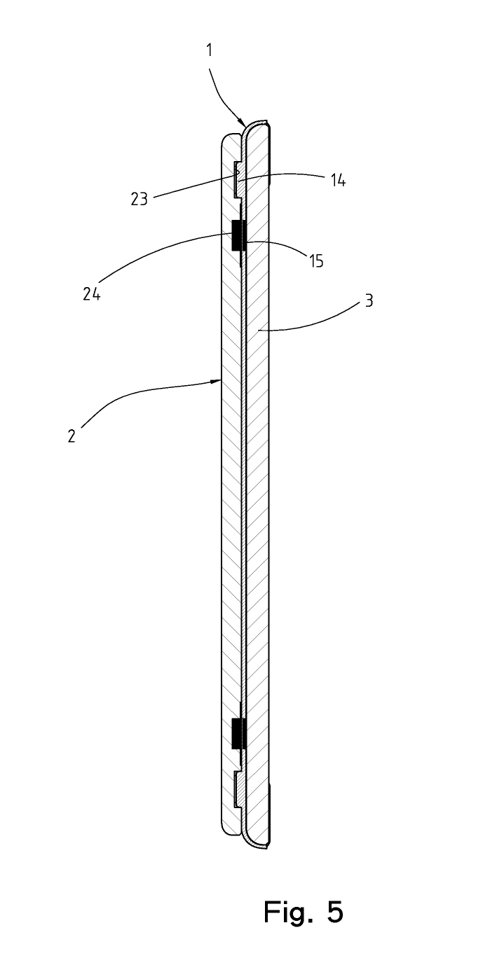

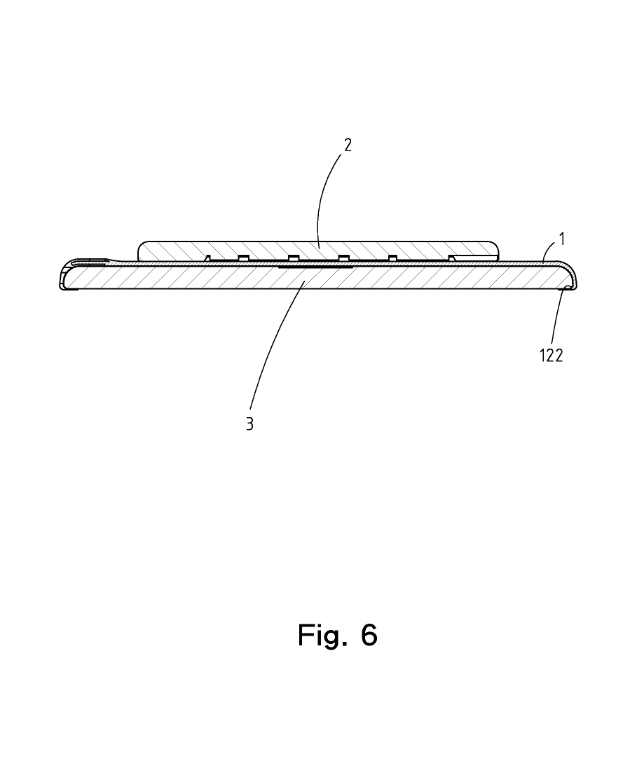

Please refer to FIG. 1 to FIG. 6, illustrating a exemplary embodiment of a combination of an input device 2 and a protective cover 1. FIG. 1 is a perspective view of an exemplary embodiment of a combination of an input device 2 and a protective cover 1 according to the present invention. FIG. 2 is an exploded view of the exemplary embodiment of the combination of an input device 2 and a protective cover 1 according to the present invention. FIG. 3 is another perspective view of the exemplary embodiment of the combination of an input device 2 and a protective cover 1 according to the present invention. FIG. 4 is another exploded view of the exemplary embodiment of the combination of an input device 2 and a protective cover 1 according to the present invention. FIG. 5 is a lateral view of the exemplary embodiment of the combination of an input device 2 and a protective cover 1 according to the present invention. FIG. 6 is another lateral view of the exemplary embodiment of the combination of an input device 2 and a protective cover 1 according to the present invention. The combination of an input device 2 and a protective cover 1 described herein includes a protective cover 1 and an input device 2. The protective cover 1 can be made of plastic, metal, wood, rubber, thermoplastic polyurethane (TPU), polyvinyl chloride (PVC), polymethyltethacrylate (PMMA), polycarbonate (PC), engineering plastic or resin. The input device 2 can be a keyboard or a writing pad, and can include a wireless transmitting module using wireless access point (WAP), bluetooth, Wi-Fi, or Wi-Fi Direct for information transmission.

The protective cover 1 includes a base plate 11, a plurality of lateral walls 12, at least one first positioning portion 14 and at least one first magnetic portion 15. The lateral walls 12 are connected to a periphery of the base plate 11 so as to define an accommodating space 13 for accommodating a mobile device 3 along with the base plate 11. The mobile device 3 can be a tablet, a mobile phone, a PDA or similar electronic devices. One of the lateral walls 12 includes at least one notch 121 corresponding to buttons or connecting ports of the mobile device 3, so that a connection cable can connect with the mobile device 3 through the notches 121 of the protective cover 1 upon the mobile devices 3 are combined with the protective cover 1. Furthermore, an upper periphery of each lateral wall 12 includes at least one engaging portion 122 provided to engage with the mobile device 3 to prevent the mobile device 3 from detaching off the protective cover 1. Additionally, the bottom of the base plate 11 includes at least one heat dissipation vent corresponding to the dissipation vent of the mobile device 3.

The first positioning portion 14 is disposed at an outer surface 111 of the base plate 11, and the outer surface 111 is opposite to an opening of the accommodating space 13. The first magnetic portion 15 is disposed at the base plate 11.

The input device 2 includes an input region 21, a frame region 22, at least one second positioning portion 23 and at least one second magnetic portion 24. The input region 21 can be a keyboard region or a writing pad region. The frame region 22 surrounds the input region 21. The second positioning portion 23 is disposed at the frame region 22 and detachably engaged with the first positioning portion 14. The second magnetic portion 24 is disposed at the frame region 22 and magnetically and detachably adhered with the first magnetic portion 15. Note that in some implementation aspects the number of the first positioning portion 14, that of the second positioning portion 23, that of the first magnetic portion 15, or that of the second magnetic portion 24, can be plural, and the first positioning portions 14, the second positioning portions 23, the first magnetic portions 15 and the second positioning portions 24 are respectively located at the corners of the base plate 11 and the input region 21. Accordingly, as shown in FIG. 2 and FIG. 4, the input device 2 is detachably fastened with the outer surface 111 of the protective cover 1.

As shown in FIG. 4, the first positioning portions 14 and the first magnetic portions 15 are, respectively, arranged symmetrically on the base plate 11 longitudinally or latitudinally, the second positioning portions 23 and the second magnetic portions 24 are, respectively, arranged symmetrically on the frame region 22 longitudinally or latitudinally.

In this embodiment, the first positioning portion 14 is a protrusion, and the second positioning portion 23 is a recession, but embodiments are not limited thereto. In some implementation aspects, the first positioning portion 14 is a recession, and the second positioning portion 23 is a protrusion. With the fool-proofing structure profiles, the second positioning portion 23 can be easily engaged with the first positioning portion 14, thereby allowing the user to fasten the input device 2 with the protective cover 1 detachably. Furthermore, with the engagement between the first positioning portion 14 and the second positioning portion 23, the connection between the input device 2 and the protective cover 1 can be improved to avoid the input device 2 detaching from the protective cover 1 upon being impacted unintentionally.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A combination of an input device and a protective cover, comprising:
a protective cover, comprising:
a base plate;
a plurality of lateral walls, connected to a periphery of the base plate so as to define an accommodating space for accommodating a mobile device along with the base plate;
at least one first positioning portion, disposed at an outer surface of the base plate, the outer surface opposite to the accommodating space; and
at least one first magnetic portion, disposed at the base plate; and
an input device, comprising:
an input region;
a frame region, surrounding the input region;
at least one second positioning portion, disposed at the frame region and detachably engaged with the at least one first positioning portion; and
at least one second magnetic portion, disposed at the frame region and magnetically and detachably adhered with the at least one first magnetic portion, thereby allowing the input device detachably fastened with the outer surface.

2. The combination of an input device and a protective cover according to claim 1, wherein the first positioning portion is a protrusion, and the second positioning portion is a recession.

8. The protective cover according to claim 7, wherein the first positioning portion is a protrusion or a recession.

9. The protective cover according to claim 7, wherein the at least one first positioning portion is embedded within the base plate of the protective cover.

10. An input device, comprising:
an input region;
a frame region, surrounding to the input region;
at least a second positioning portion, disposed at the frame region; and
at least a second magnetic portion, disposed at the frame region.

11. The input device according to claim 10, wherein the second positioning portion is a protrusion or a recession.

3. The combination of an input device and a protective cover according to claim 1, wherein the first positioning portion is a recession, and the second positioning portion is a protrusion.

4. The combination of an input device and a protective cover according to claim 1, wherein the at least one first positioning portion is embedded within the base plate of the protective cover.

5. The combination of an input device and a protective cover according to claim 1, wherein the number of the at least one first positioning portion is plural, the number of the at least one second positioning portion is plural, the number of the at least one first magnetic portion is plural, the number of the at least one second magnetic portion is plural, the first positioning portions, the second positioning portions, the first magnetic portions and the second positioning portions are respectively located at the corners of the base plate and the input region.

6. The combination of an input device and a protective cover according to claim 5, wherein the first positioning portions and the first magnetic portions are, respectively, arranged symmetrically on the base plate longitudinally or latitudinally, the second positioning portions and the second magnetic portions are, respectively, arranged symmetrically on the frame region longitudinally or latitudinally.

7. A protective cover, comprising:
a base plate;
a plurality of lateral walls, connected to a periphery of the base plate so as to define an accommodating space for accommodating a mobile device along with the base plate;
at least one first positioning portion, disposed at an outer surface of the base plate, the outer surface opposite to the accommodating space; and
at least one first magnetic portion, disposed at the base plate.
